(19) United States
(12) Patent Application Publication
(10) Pub. No.: US 2008/0249652 A1
(43) Pub. Date: Oct. 9, 2008

(54) Method and Apparatus for Apparel Customization

(76) Inventor: Elizabeth Burr, San Francisco, CA (US)

Correspondence Address: GLENN PATENT GROUP, 3475 EDISON WAY, SUITE L, MENLO PARK, CA, 94025, US

(21) Appl. No.: 11/914,100

(22) PCT Filed: May 10, 2006
(86) PCT No.: PCT/US06/18143

§ 371 Date: Apr. 24, 2008

Related U.S. Application Data
(60) Provisional application No. 60/679,700, filed on May 10, 2005.

(51) Int. Cl. G06F 19/00

(52) U.S. Cl. 700/132; 700/131

(57) ABSTRACT

A unique methodology for apparel mass-customization is provided. Tracers, precision garments designed for fitting at a store site, are provided. Tracers work in conjunction with a unique Clip and Alteration Point relationship. A database of customers' unique digital fit data is provided. Such data are used by a configured system to generate patterns reflecting a customer's personal size as well as level of comfort. [Virtual inventory is enabled by such stored data and are applied to electronic patterns with no shelf life.] The database allows customers to reorder additional pants in new styles and fabrics at any time. Automated patternmaking algorithms are used that dynamically adjust patterns to the data; core style patterns are adjusted to fabric specifications. A sophisticated manufacturing process provides separates and independent sub-processing, such as kitting, enabling cost-effective and rapid one-at-a-time apparel creation. An exemplary channel kiosk and channel kiosk with scanning are provided.

### BACKGROUND OF THE INVENTION

1. Technical Field

The invention relates generally to apparel. More particularly, the invention relates to a system and method for apparel mass-customization.

2. Description of the Prior Art

### “Nothing fits me. I'm just not in shape. I feel so wrong.”

### “I can't find pants that fit, in styles I like, at a price I can afford.”

Common problems like these exist in the apparel industry and frustrate customers as well as merchants. For example:

Fit: Pants don't fit because bodies come in many shapes, i.e. not the seven standard women's sizes typically found in most stores. Most apparel designers' sizing blocks have been built on models in their twenties, resulting in apparel that is ill-fitting on less than “perfect” bodies that has increasingly poorer fit as bodies change with aging.

Style: The current designer-driven model of apparel churns out cookie cutter styles that appeal to the few.

Stock: Stores run out of stock in sizes and colors such that if a customer finds a style he or she likes, then it is often out of stock in their size or color preference.

Reorder: If a customer finds a style he or she likes that fits, he or she can't easily get it again because stores only keep basic apparel in stock from season to season, whereas fashion styles are constantly replaced by new ones.

Another common problem in the apparel industry is that retailers walk sales, further depicted as follows:
The retailer's “if-only” problem:
“I'd buy this if only it came in a different color . . . ”
“I'd buy this if only it fit better in the waist/hips/ . . . ”
“I'd buy this if only it had pockets . . . ”
“I'd buy this if only it you had it in my size . . . ”

High finished Goods Inventory: Retailers struggle under the burden of a high finished goods inventory to generate retail volume.

Merchandise Risk: Retailers must gamble each season on what customers will want.

Conversion Rate: Sales volume is dependent on converting foot traffic into sales. When a store is out of stock in a size or a color or a style—a sale walks out the door.

Margin Pressure: Retailers are dependent on markdowns and advertised sales to move goods, putting pressure on margins. Customers are savvy to the inventory burden and will wait for markdowns and clearance sales.

Such are common problems of today. How are these problems addressed today?

New Fit Blocks: Mass retailers develop new sizes based on different body shapes and market their new fits to customers. But: This increases the inventory investment and floor space necessary to be in stock.

Easy Fit Clothes: Some retailers have resorted to selling clothes in loose, one size fits all styling, i.e. elastic waists and baggy knits, to eliminate problems associated with fit. But: Customers want great styles that fit them, not baggy clothes.

Online Fit Services: Customers measure themselves, send in their measurements online, and a garment is sewn for them. But: Over 95% of fashion apparel is purchased in stores, not online and self-reported measurements are not accurate.

Custom Ateliers: Retail custom clothing studios provide expensive, tailored clothes.

But: This is not an affordable solution for most customers

It is evident that such solutions aren't satisfying customers or improving profitability for retailers. It would be advantageous to provide a system and method that provides an easy and scalable solution.

Presently, measuring methodologies are employed as techniques toward generating a final garment. That is, the traditional tailoring technique is as follows:
Tape Measurements→Draft Garment→Final Garment

The Online and scanning customization technique is as follows:
Tape Measurements→(skip Draft Garment)→Final Garment

It would be advantageous to eliminate the step of tape measurements for a variety of reasons, for example eliminating embarrassing and cumbersome fitting sessions for both the salesperson and the customer.

A measuring methodology is discussed by Robert Gordon Ernest Holloway, Jeffrey Aldredge Luhnow, Steven Carl Heard, and Philip J. Ramsey, U.S. Patent Application Publication, U.S. Patent Application Publication 2004/0093105, METHOD FOR CUSTOM FITTING OF APPAREL, published May 13, 2004. The technique to Holloway et al (herein Holloway) is directed to custom fitting an article to a human being. Holloway et al disclose obtaining a first set of values of a first set of body dimensions by report of the human being; computing a second set of values of a second set of human body dimensions from the first set of values of the first set of human body dimensions by using a mathematical model; defining a set of article dimensions; providing a second mathematical model relating the article dimensions to the first set of human body dimensions and the second set of human body dimensions; computing a third set of values of the set of article dimensions from the first set of values of the first set of human body dimensions and the second set of values of the second set of human body dimensions by using the second mathematical model.

It is readily apparent that the Holloway technique is based on and requires using body measurement towards the end product. Nowhere does Holloway disclose eliminating the requirement for taking the body measurements in the traditional sense of the consumer.

### SUMMARY OF THE INVENTION

A unique approach to apparel mass-customization based on an alteration methodology is provided. Alteration methodology eliminates the tape measurements step. Tracers, unique fitting garments that are precision garments designed for fitting at a store site are provided, working in conjunction with a unique Clip and Alteration Point relationship. A methodology and a database of customers' unique digital fit data are provided where the data is used by a configured system to create patterns and ultimately the garments in a customer's personal size and level of comfort. Such data, referred to as Alter.dots are applied to electronic patterns which exist as virtual inventory with no shelf life. The customer database allows customers to reorder additional pants in new styles, new fabrics at any time. Automated patternmaking algorithms are used that dynamically adjust patterns to Alter.dot data; fabric coefficients are used that adjust core style patterns to fabric specifications. A sophisticated manufacturing process is provided that separates sub-processes into independent processes, such as kitting, that enables cost-effective and rapid one-at-a-time apparel creation. An exemplary channel kiosk and channel kiosk with scanning are provided.

### BRIEF DESCRIPTION OF THE DRAWINGS

FIG. 1 is a schematic flow chart describing high level steps from a consumer getting fitted for a garment to receiving the garment;

FIG. 2 is a schematic diagram showing the front and back views of a Tracer for a pant and a smart clip;

FIG. 3 is a schematic diagram showing an exemplary system architecture for implementing aspects of apparel mass-customization;

FIG. 4 is a schematic interactive diagram showing the relationships between various elements concerning apparel mass-customization;

FIG. 5 is a schematic diagram of a database schema for apparel mass-customization;

FIG. 6 is a schematic diagram showing an array of sample screens and reports that can be used for apparel mass-customization;

FIG. 7 is a schematic diagram showing an exemplary system architecture for implementing aspects of apparel mass-customization;

FIG. 8 is a schematic diagram showing an exemplary channel kiosk for implementing aspects of apparel mass-customization; and

FIG. 9 is a schematic diagram showing an exemplary channel kiosk with scanner for implementing aspects of apparel mass-customization.

### DETAILED DESCRIPTION OF THE INVENTION

A unique approach to apparel mass-customization is provided. A technique is provided that is scalable, i.e. built from the ground up to easily roll out and implement in the field. It is easy and familiar to the customer, i.e. a process is provided that mirrors the existing customer experience of trying on a pair of pants. A rich back-end technology is provided that a company can manage in-house and ensure simplicity and ease for roll out in the field. Stores don't need to invest in complex technology, commit large amounts of selling space, or engage in sophisticated training of their staff. A technology is provided that is includes an engine for mass customization of apparel for companies from high end retail to low end retail and any brand or private label retailer. Using the provided base technology, retailers are allowed to improve customer retention, inventory turns, and margins by implementing the technology.

Retailer Benefits

A technology is provided that enables apparel retailers to easily implement mass customization of pants at the store level, as follows.

No Investment in Finished Goods Inventory: Pants are made to order.

Reduced Merchandise Risk: Customers order the styles they like with the details they want, no need for the retailer to gamble on what customers will want.

Increased Conversion Rate: Retailers can solve the “if only” problem, providing pants that fit, with details customers want.

Margin Opportunity: Pants are sold at regular price, i.e. no need for markdowns because a retailer holds no inventory. Provides a regular price selling opportunity even during heavy markdown seasons.

Customer Benefits

Customize your coffee . . . Customize your computer . . .

Now, customize your clothes.

The provided technology enables customers to get pants that fit, in the styles they like, with the details they want, at a price they can afford.

Fit: Each pair of pants is made from a unique profile, i.e. incorporating a customer's personal size and fit preferences.

Style: Styles are fashion-right and allow customers to determine personalized details such as fabric, pockets and buttons.

Stock: Pants are made to order, so a customer's personal size is always “in stock.”

Reorder: Inventory is electronic and essentially timeless. Reordering is easy regardless of season. New styles are added all the time and old styles don't disappear.

Four Key Elements to the Technology

Tracers: Proprietary fitting garments called Tracers that are precision garments designed exclusively for fitting at the store site. They are developed through extensive testing of the key points on garments that most closely correlate with fit.

Customer database: A database of customers' unique digital fit data, the data sometimes called an Alter.dot, is the data used by a provided and configured system to create garments in a customer's personal size. Alter.dots “are applied to electronic patterns that exist as “virtual inventory” with no shelf life. The customer database allows customers to reorder additional pants in new styles, new fabrics, with new details at any time.

Automated Patternmaking Algorithms: A set of automated patternmaking algorithms that dynamically adjust patterns to Alter.dot data is provided. The algorithms include complex style correlations that allow an Alter.dot to create pants in any style. Fabric coefficients are provided that adjust core style patterns to fabric specifications.

Redesigned manufacturing flow: A sophisticated, re-tooled manufacturing process that enables cost-effective and rapid one-at-a-time apparel creation is provided.

It has been found that Alter.dot technology can currently be used to fit women in sizes 0 to 16, regardless of body shape, i.e. straight, curvy, missy or petite. The technology can be leveraged to new blocks, i.e. women's large sizes, new categories, i.e. skirts, jackets and the like, new markets, i.e. men's, children's, new styles, and new fabrics.

It has been found that approximately 80% of customers create their personal Alter.dot in only one Tracer fitting. Once an Alter.dot is established, a customer can order and be assured their pants will fit, regardless of style, over 90% of the time.

### Fit Customization Methodologies

Determining a customization methodology is a critical first step. Currently, there are several methods used to create customized apparel. The methods vary in accuracy and scalability. The primary differences are in how customer data is gathered and in how patterns are adjusted to accommodate that data. The two steps are interrelated, i.e. the pattern adjustment method you choose impacts the type of data you need to gather and vice versa. These methods are discussed below:

Current Customization

Historically, custom clothing has involved a two-step, time and labor intensive, process. A custom clothing customer is carefully measured by a skilled tailor. A loosely sewn “draft” garment is created and the customer returns for a second fitting, now using the garment as a gauge, not body measurements. The garment is directly altered after this second fitting in order to create the best final fit.

Apparel mass customization methods have attempted to streamline this time and labor intensive process. Most current apparel mass customization methods attempt to skip the second fitting (the alteration step) and instead build garments directly from body measurements. With this current method, electronic patterns are adjusted based on body measurement data.

Body Measurement Methodology

There are several ways of gathering body measurements: a) professional measurement by tape measure; b scanning); and c) self-reported measurements. Body measurements are two-dimensional (2D), i.e. they don't take into account the three-dimensional (3D) shape of the body. As a result, body measurement data have limited reliability in customizing a garment for fit. Body measurements taken by a scanner are more accurate than a tape measure, but like tape measurements, currently do not factor in 3D shape. While a scanner has a 3D view, current scanning technology takes a large number of measurements but merely translates the scanned data into 2D measurements. Self-reported measurements are highly inaccurate and unreliable. As a result, most self-reported measurements need to be accompanied by answers to a detailed questionnaire about height, weight, clothing sizes, exercise frequency, body shape etc. in order to infer what the true body measurements may actually be.

Pattern Adjustment using Body Measurements

To adjust a pattern using body measurements, the pattern first needs to be associated with the body measurements from which the pattern was originally made, i.e. typically the fit model's measurements. Naturally, the pattern measurements don't match body measurements because there is looseness and tightness in different parts of a garment, depending on the designer's intended look. There are currently three key ways to adjust patterns using body measurement data.

Manual made-to-measure: The first method is what is used in the current made-to-measure market, such as wedding dresses, Hollywood costumes, tailored suits, and the like. An existing electronic pattern is adjusted manually in a variety of places depending on a specific customer's measurements. Like traditional tailoring, this method often requires a second fitting of a draft garment.

Rule-based Adjustments: The second method is to develop a set of rules that instruct how the patterns should change to adjust to body measurement data. This allows for some degree of automation in the pattern adjustment process. Specific body measurement points are selected and then associated with certain points on the garment. Body measurements are taken at those points only and the closest sized pattern is adjusted according to a set of predetermined rules. Accuracy is highly dependent on the adjustment rules as well as the body measurement data itself. Over time and with experience it is possible to make the adjustment rules smarter.

Pre-built pattern set: The third method involves creating a large set of patterns, i.e. on the scale of hundreds, before any selling takes place. When the body measurement data is provided, usually self-reported, mathematical correlations select the closest pre-existing pattern that most closely matches the body measurements provided.

Provided herein is a methodology that involves 3D body scanning that essentially can map a 2D pattern to a customer's 3D body shape. This does not involve any tape measurements, but each pattern still requires a rule set to clarify how a pattern should be shaped to a 3D body scan.

Alteration Methodology

Historically this has been the final step in getting a garment to fit. Adjustments are made directly to a pattern or garment based on how a garment fits, not on body measurement. This requires that the customer try on the garment or a sample. This method is generally very accurate. It is currently the best way to factor in 3D fit issues. This method also allows for a customer's personal preferences on fit, e.g. looseness and tightness, to be incorporated into the final garment. Relative to body measurement, this is a more private and less invasive method for customers because there is no embarrassment about body measurements and the customer is clothed in a sample garment.

It should be appreciated that one embodiment of the invention provides alteration methodology in a mass customization environment.

Alteration Data Gathering: A customer puts on the garment and it is pinned, marked, or otherwise noted for how it should be adjusted. There are two ways to get this data; a) from a trained person (alteration professional, salesperson or other individual) seeing the garment on the customer or b) self-reported.

Pattern adjustment using alteration data: Typically an alteration is done directly on a garment. However, in the business of clothing design, a pattern is altered, typically by a patternmaker, in a CAD system, after a garment is fitted on a professional “fit model”. The fit model tries on the garment and adjustments are then made to the pattern and another garment is then sewn based on the alterations and again fitted on a fit model. This is typically labor intensive but some CAD systems can be adapted to accommodate automated input as long as a set of alteration rules have been put in place.

An Exemplary Alteration Methodology for Mass Customization

One embodiment of the invention provides an alteration methodology for mass customization, also referred to herein as a Lucy and Lily approach or methodology. To effectively gather data for mass customization, a standardized garment, a set of specific alter points on each standardized garment, and a standard for determining and capturing the alteration information are provided. There are a variety of possibilities of the alteration method. Because it is believed that the customer wants to try on a garment, it is used as a critical data point, i.e. where the richest data and personal preferences can be gathered. It is believed that even with automation, this method is more accurate than body measurement. To implement such methodology, it can be desirable to:
Standardize and automate the garment alter points and create a set of proprietary alteration rules;
Train salespeople on how to effectively gather the alteration information; and
Identify how to hold onto the data for each customer and how to apply it to other garments, regardless of brand or manufacturer.

### Operations

CAD System

A configured CAD system, such as for example, the Gerber CAD system by Gerber Technology, can allow the user to create digital patterns that can ultimately be sent to a computerized cutting machine. Such a CAD system can handle pattern adjustment processes and development of proprietary pattern adjustment rules. The Gerber system, for example, is flexible and rich in features, and Gerber Technology designs and manufactures computerized cutters, providing a system that can easily integrate patternmaking and cutting.

Cutting

As background, it can be appreciated that a key element of mastering mass customization is in managing fabric and the cutting process correctly. Unlike mass production which cuts one fabric on huge, multi-ply cutters, mass customization requires that customer orders be cut individually, either manually or on an automated single ply cutter and often in a variety of types of fabric.

Manual Cutting: Manual cutting is fairly easy, though time consuming and very expensive. Each garment is cut individually on a large cutting table with scissors. There is little emphasis on using fabric efficiently. It is fairly easy to manage the fabric pieces for each order. Manual cutting is not scalable.

Computerized cutting: Automated single-ply cutting is fast and a vital part of scalable mass customization. It requires a computerized single-ply cutter and mastering a number of process steps. The challenges to computerized cutting for mass customization are the following:
Batching the cutting: As orders come in individually, they need to be grouped by fabric, so that the fabric roll only needs to be loaded or spread out once for multiple orders.
Nesting: Orders need to be laid out in such a way to most efficiently use the fabric. This may mean that different customer's pieces are intermingled on the fabric before cutting. This process is called nesting and most CAD systems provide a software module that will nest multiple pattern pieces and create one cut file.
Kitting: The cut pieces need to be separated then grouped or kitted by order so that all pieces for a garment, including buttons, zippers, sewing instructions, and other trims, are in a kit ready to be sewn. This often requires some kind of marking process while the cutting is taking place to distinguish which pieces go into which kit. This can be done by stickers with bar codes or other distinguishing marks or by literally marking the fabric pieces with some sort of temporary marking.

One embodiment of the invention provides herein a methodology that separates the cutting process from the sewing process for maximum flexibility. Another embodiment of the invention provides a computerized cutter that is located in the same place where the fabric inventory is housed.

### An Exemplary Technical Solution

A technical solution is provided that incorporates building a standard size and then measuring each customer's difference to this standard, i.e. with an agreed tolerance, modifying the pattern accordingly, and building the garment, e.g. the pant one off, i.e. one at a time, using the modified pattern.

It should be appreciated that in this method, there are issues of the difference between 2D flat measurements and the actual 3D construction and fit of the pant, i.e. the pelvic region is actually a complex 3D shape, not just a collection of linear measurements like a 32″ waist, 30″ inseam, 6″ rise, etc.

To make sanity and provide the ability to actually produce many pants in an assembly line or modular fashion with high quality, i.e. essential for the ability to scale/volume as well as provide a good quality/price point ratio, only certain aspects of the pant are adjustable, while others are fixed. By limiting the number of adjustable parameters, the number of people who can fit them is also limited, i.e. that find the fit acceptable.

To expand the number of people, which the provided methodology can fit, the provided methodology creates different blocks. Blocks represent different shapes and ratios of the fixed elements of the pattern, especially when considering the overall 3D shape of the pelvic region.

The methodology provides for each pant, different parameters that are adjustable and, thus, measurable. Such parameters can be taken in by, i.e. are input to, the CAD system, which produces a custom pattern.

Measuring the Person and the Pant

According to the methodology, one or more Tracers are provided such that when a customer comes into the store, based upon his or her usual size, he or she tries on several Tracers available until he or she gets one that is a good fit and perhaps a bit big. The personalized measurements are a reduction in size, i.e. making the Tracer smaller. One exception may be concerning the inseam or length, where an increase in length is allowed.

Then for this specific Tracer, which is of a specific block, there are certain parameters that are adjustable. Examples of such adjustable parameters are waist (side, front and back), high hip, mid hip, low hip, knee, and inseam. Each one of these measurements are a reduction, i.e. “how much do we have to take in,” to achieve a better fit for the customer.

Not only is how much taken in assessed, but the methodology gives the customer the physical opportunity to feel the adjustment, e.g. pin up the pants, to let the customer walk in the Tracer, and to sit in the Tracer to make sure that the adjustments are not too much, nor too little. In addition, some customers as a personal preference prefer a tight fit and some prefer a loose fit.

There is also a psychology to the fitting process. Some women do not want to be measured or have others know their measurements. This concern is important to sales.

Pins can have their dangers and can be nuisances. The methodology provides clips, which are easily usable by the usual clothing store salesperson's skill and competency level.

Clips

One base idea uses Clips to pinch up the excess fabric in the proper amount. This allows the measurer and customer to see in a mirror and feel if enough of the extra fabric has been clipped up. The Clip is strong enough to allow the Customer to walk around and sit down in the clipped pant to verify that it has been taken in the right amount.

Once the garment, or pant, is clipped, then the amount of fabric that particular measurement being reduced is measured. This is preferably done in a manner that directly fills in the order form software on a nearby computer/POS cash register. That is, there is no need for writing down numbers on a piece of paper which is carried over to a computer and then typed in.

Following are design issues considered when clipping a pant for gathering alteration data. It should be appreciated that it is readily apparent to one skilled in the art can recognize specific detailed references are for illustrative purposes and are not meant to be limiting:
A pant, for instance a jean, is often composed of 4 parts, i.e. left front and rear, and right front and rear. If one clips a one inch reduction in waist, then that could correspond to ¼″ reduction in each of the four parts. Depending on the style of the pant, a matrix of alteration algorithms determine how the one inch reduction could be spread among the pattern pieces of the garment. Dealing with this calculation is done in the CAD software system. It is important is to understand that the measurement on the customer is not the same as the actual measurement used for manufacturing. As another example, around the waist, one likely takes four measurements. This allows for different alterations at front, back and side seams depending on how the pant fits.
When one clips a pant, one takes on the inside of the pinch point of the clip a certain amount of fabric.
Each measurement parameter is not stand-alone, they each affect the neighboring points. If one takes just the waist in an inch, some small consequent adjustment down the hip parameters also has to be made for the silhouette of the pant to look good. Most of this adjustment is done by adjustment algorithms that determine how the pattern will adjust in the CAD system. However, it is important to understand that these measurements are part of a whole.
The smallest increment for every measurement is ¼″ and the tolerance is ±a ¼″.
If one clips only on one side, an accurate measurement is still provided.
How one measures such take up portion accurately and consistently across multiple customers and salespersons is significant to success, because there has to be a repeatable/consistent method of multiple salespeople getting the same numbers for the same customer.

The Tracer can be labeled, modified and enhanced in whatever way required. It is a model that does not leave the store. One can print or paste on measurement tapes, or sew in any sort of technical/metallic/specialized fibers, etc. that are needed to make the measurements work.

In another embodiment of the invention, at each pattern point, a bar code and a handheld bar code reader is used in lieu of or in combination with clips. The handheld device takes in the data from each point and uploads that data to a computer.

It should be appreciated that in this way the methodology contemplates adding more intelligence to garments, e.g. pants, via barcodes, smart clips, and the like, as scan codes help to reduce errors in the field.

In another embodiment of the invention, each pant that is manufactured has a unique, personalized tag that displays the customer's pattern profile number as well as the style of pant they ordered. That is, the customer's unique style/fit choice number is put on the tag of each garment and with that the customer can re-order the exact same pant in the same or new fabrics.

Wireless communications as well as cables both work well, e.g. barcode scanners with cable to the computer. Because typically there are no Information Technology (IT) people in any given store and the salesperson typically only has basic computer skills, then it is desirable that the equipment be robust, reliable, not finicky, and work sixteen hour days for months on end.

### Fit Technology and Fit Rules

Two key elements to building Fit technology/Fit Rules are as follows:
Data Gathering; and
Pattern Adjustment.

Data Gathering

There are a number of ways to gather measurement data to create a customized fit, including scanning technology and the methodology as described hereinbelow, referred to herein as L&L Data Gathering.

L&L Data Gathering

Some objectives of the implemented data gathering method are as follows:

Is relatively easy to roll out and implement in the field
Apparel retailing is notorious for high employee turnover and complex training is a barrier to implementation.
A goal is to build as much fit intelligence into the system, so needs are limited for skilled personnel in the field.
If the user doesn't own the channel, a necessary capital investment by a retailer in complex measurement equipment, i.e. a scanner, may be a barrier to implementation.
Square footage usage must be productive so the process requires a limited footprint in a store.

Strikes a Balance Between Ease and Accuracy
The data preferably provides the user with enough accurate information, including fit preferences, to satisfy the customer.
The method needs to be fairly accessible, easy for the customer. Customers must perceive that the time spent both in data gathering and in waiting for their garment is worth the effort.

Allows Data to be Taken Once and Applied to Many Styles and Fabrics

It is desirable to take in one data set for each customer that can then form a preference profile that can be applied to many different styles and fabrics.

The current available methods to gather data are as follows:

Tape Measure/Body Measurement usually requires another fitting in which a basted garment is then altered. For best results, this method requires tailoring expertise. Self-reported tape measure data tends to be highly inaccurate. Scanning can be accurate and presents a future opportunity.

Garment Alteration data: This incorporates a customer's preference. It is fairly easy for an unskilled person to gather this data.

The system and method focuses on gathering alteration data instead of tape measure data, as this is easy to implement in the field, is fairly accurate, and allows the user to fairly easily gather customer fit preferences, such as tightness/looseness.

One provided gathering method can be perceived as low tech, i.e. clips. Women try on a pant that we are currently using as our baseline and we use clips to gather the pant at key points until it feels comfortable for the woman. We then measure the changes to the garment at those points and record it. There is no measuring tape involved, women are clothed, and the process can be done with friends looking on without embarrassment. It's fairly fast as well. The data is then input manually into the CAD system. Ultimately the data is directly entered into a system in the field and flow to the CAD system automatically.

In another embodiment of the invention, scanners are used in measuring. Software is developed for the scanner.

Pattern Adjustment

Patterns can be adjusted manually by a patternmaker or automatically. Provided is a proprietary set of rules that drive the CAD system to alter the garments automatically.

L&L Fit Rules/Pattern Adjustment

One goal for apparel mass customization is to have one data gathering session for a customer and leverage that data across as many styles and fabrics as possible for the customer. One embodiment of the invention provides a standardized garment and a set of corresponding automated rules. Success of such set of automated rules with the corresponding garment can be measured using the following benchmarks, as described hereinbelow.

First Iteration of Development
One style/one fabric; and
Eight or fewer alteration points on the garment.

Second Iteration of Development

Same as first iteration, but data gathered from one pant (interchangeably, garment) can be applied to the same style in multiple fabrics, i.e. so the customer can order in multiple fabrics with one data gathering.

Third Iteration of Development

Same as second iteration, however data gathered from one pant or garment are used across all styles in all fabrics in the same block.

This makes it easier for users of the methodology to leverage the Web for reorders without needing a try on session for each order.

It should be appreciated that the methodology contemplates gathering data that alters a garment and not body measurement data and intelligence that translates that data to other styles.

Cutting and Kitting

One embodiment of the invention establishes a process and system to manage the flow of cut pieces that need to be kitted before sewing. One process starts with a penned marker, a large piece of pattern paper that sits on the fabric while it is cut. The methodology contemplates ensuring that the customer's name and order information stays with the garment as it is in process.

An Exemplary Functional Design for Personalization Orders In one embodiment of the invention, the customer selects a pant that they wish to buy. The following facts are provided as input from the customer:

Customer Name, etc. (this produces a Customer No.);

Style No./Name;

Fabric No./Name;

Color No./Name, possibly a separate value in popular materials with many colors;

Size; and

Block (A, B, C, etc.).

The correct Size/Block is determined as follows:

An operating principle is that the methodology does not personalize UP in size. That is, the methodology contemplates the measuring process by starting with a big Tracer and then shape to a smaller fit, as opposed to altering out. Exceptions are for the Inseam, i.e. length of pant, and possibly letting out the waist a bit.

The salesperson follows the guidelines hereinbelow for checking the Size/Block:
How does the fit look in the waist, seat, rise, thighs, upper, mid, lower hip, bunching, tightness, etc.; and
Over time one gains experience and intelligence of what data/items to look for that indicate the need for a different Size and/or a different Block.

At this point or subsequent, it may be determined that that the person cannot be fit with a given and current range of sizes and blocks.

When the correct Size/Block is determined:

Either it is a perfect fit or it needs fit customization. The salesperson then clips the following standard fit customization points on the Tracer, such as:
Waist;
High Hip;
Mid Hip;
Low Hip;
Thigh; and
Inseam per their desires, accounting for usual heel size, etc.

It is advantageous to keep the Fit Customization Points standardized across every pant. After the Customer approves the adjustments, e.g. verbally after viewing themselves in a mirror, the Salesperson then records values representing the adjustments.

For illustrative purposes only, and not meant to be limiting, examples of the adjustment values are shown hereinbelow:
0;
¼;
⅜ inch;
½ inch;
1;
yes; and
no.

Order details and Customer Information are collected, including:
Money;
Delivery Method, such as shipper and speed; and
Delivery Location, such as Store and Customer Location.

A delivery date or range is then provided by the methodology to the customer.

Table A hereinbelow is a sample customer order page for illustrative purposes only and is not meant to be limiting. Such page can be used when at Trunk shows or when otherwise not connected to a computer. Instructions accompanying the sample order page in Table A can be as follows: The Size boxes are for checkmarks, only one checkmark per row. Each row must be filled in with at least zero to signify that the adjustment was taken and nothing needed to be done. Inseam can be increased or decreased, thus the separate Plus/Minus box to take the amount, an actual measurement, of the increase/decrease. Separating out the values eliminates the confusion over the plus/minus sign.

TABLE A

| Customer Information | | | Store |
|---|---|---|---|
| First | Last | | Store |
| Address | | | Salesperson |
| City | State | Zip | Order Date |
| Day Phone for Delivery | | | Office Use |
| Delivery Address | | | Entry Date |
| City | State | Zip | |
| Email | | | |

| Style Personalization | Adjustment | 0 | ¼ | ⅜ | ½ | ¾ | 1 |
|---|---|---|---|---|---|---|---|
| Style | Waist | | | | | | |
| Fabric | High Hip | | | | | | |
| Color | Mid Hip | | | | | | |
| Monogram | Low Hip | | | | | | |
| Button Choice | Thigh | | | | | | |
| Design Thread Color | | Plus | | | Minus | | |
| | Inseam | | | | | | |
| Style | Waist | | | | | | |
| Fabric | High Hip | | | | | | |
| Color | Mid Hip | | | | | | |
| Monogram | Low Hip | | | | | | |
| Button Choice | Thigh | | | | | | |
| Design Thread Color | | Plus | | | Minus | | |
| | Inseam | | | | | | |
| Style | Waist | | | | | | |
| Fabric | High Hip | | | | | | |
| Color | Mid Hip | | | | | | |
| Monogram | Low Hip | | | | | | |
| Button Choice | Thigh | | | | | | |
| Design Thread Color | | Plus | | | Minus | | |
| | Inseam | | | | | | |

| | |
|---|---|
| Purchase | Delivery |
| Price | Delivery Home/Store |
| Sales Tax | Delivery Type (Next Day, 2-3 Day) |
| Delivery Charge | Delivery Date |
| Additional Services | |
| Total | Special Instructions |
| Deposit | |
| Credit Card (Type and No.) | |
| Credit Card (Exp. Date) | |

Delivery Calendar

Table B is an exemplary example of the steps according to one embodiment of the invention and the number of days to complete the step. i.e. Counting is by Days.

TABLE B

| | LL Office | LL Office | In Store | In Store |
|---|---|---|---|---|
| | Office | Home | Store | Home |
| Step | Pickup | Delivery | Pickup | Delivery |
| Customer Orders | 1 | 1 | 1 | 1 |
| Order Entered | 1 | 1 | 2 | 2 |
| into LL Sales | | | | |
| System | | | | |
| Grading, | 2 | 2 | 3 | 3 |
| Marking, Cutting | | | | |
| Transit to Sewers | 2 | 2 | 3 | 3 |
| Sewing | 3, 4 | 3, 4 | 4, 5 | 4, 5 |
| Transit to Packers | 4 | 4 | 5 | 5 |
| Packing | 5 | 5 | 6 | 6 |
| Shipping Time | 5 (none) | 6, 7, 8 | 7, 8, 9 | 7, 8, 9 |
| (to Delivery | | | | |
| Location) | | | | |
| Customer Receipt | 6 | 8 | 10 | 9 |

An Exemplary Shopping Experience

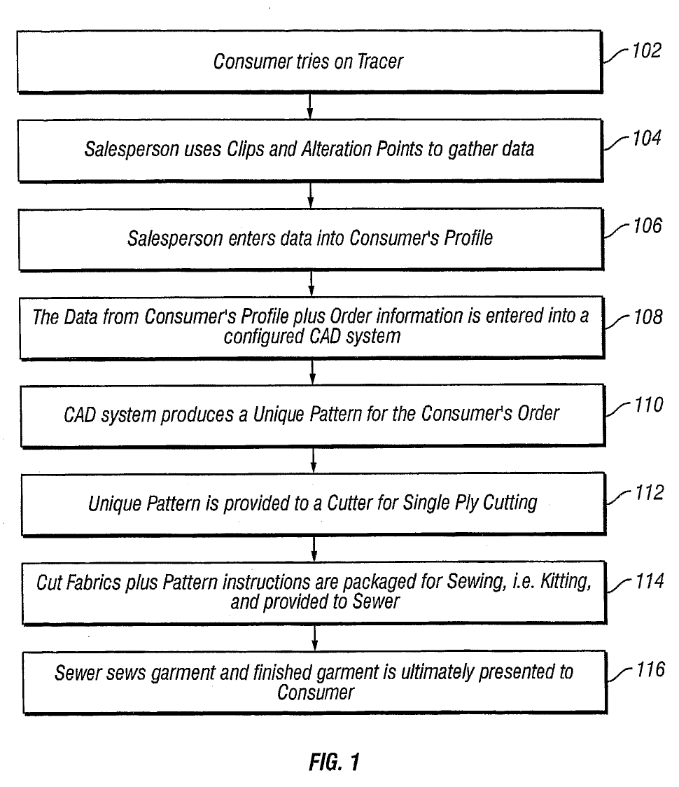

One embodiment of the invention can be described with reference to FIG. 1, a schematic flow chart describing the high level steps from a consumer getting fitted for a garment to finally receiving the garment. It should be appreciated that any specific reference to pants are for illustrative purposes only and are not meant to be limiting. As an example scenario, a consumer enters a store and desires to purchase a particular style of pant, in a particular fabric and color. First, the consumer is asked to try on a Tracer (102) so that the Salesperson can determine the fit customization preferences. Once the consumer is wearing the Tracer, the Salesperson uses Clips in conjunction with the Alteration Points on the Tracer itself to gather data that is used to determine the correct measurement of the consumer's size and comfortable fit (104). The consumer is allowed to walk around in the Tracer, sit down with the Tracer, and perform other movements, with the Salesperson present and adjusting the location of the Clip accordingly, so that the consumer achieves ultimate comfort in the Tracer, and ultimately, the manufactured garment (104). After the consumer and Salesperson are satisfied that the Clips, either alone or in combination, are properly located, the Salesperson enters the data into the Consumer's Profile (106). Such data forms the customer's Alter.dot. Entering data into the Consumer's Profile can be implemented in a variety of ways. For example, the Salesperson can enter the data on a printed table. An example of a table representing a Consumer's Profile can be found hereinbelow in Table C. The Salesperson can jot down notes and then enter the data into an online database, and so on. After denoting the consumer's fit customization preferences, both the preferences and the order are entered, either manually or automatically via a configured apparatus, into a CAD system configured to work with the input data, i.e. Alter.dot (108). The CAD system produces a Unique Pattern representing the consumer's order (110). The Unique Pattern is provided to a Cutter for single ply cutting (112). The cutter can be independent of the CAD system. The cutter and the CAD system need have had a prior agreement as to what the cutter needs, concerning the elements of and the format of the Unique Pattern, to perform the proper cutting of the fabric. After the pieces of the Unique Pattern are cut by the cutter, the pieces are gathered and packaged with trims and sewing instructions, also referred to as kitting (114). In one implementation, the pieces and the pattern are put into a single bag or box and is in shipping condition for delivery to a sewing facility. This provides flexiblilty in that the sewers do not need to be at any specific location, such as in a cutting factory. An individual sewer or one or more teams of sewers receive the kitted package and sew the garment (116). It should be appreciated that in a business environment, more steps, such as quality assurance (QA) would be performed, but are not necessary here to understand this embodiment of the invention.

Hereinbelow in Table C is an sample of a table for entering alteration, interchangeably referred to herein as adjustment, data for a consumer.

TABLE C

| Body Part | Alteration |
|---|---|
| Waist | 1 |
| Front | 0 |
| Back | 2 |
| High Hip | 0 |
| . . . | . . . |
| Low Hip | 1 |

In one embodiment of the invention, as shown in Table C, an Alteration Algorithm is provided that allows the Salesperson, and by using the Clips and Alteration Points relationship or electronic interaction Clips and Alteration Points are so configured, to enter unit numbers, such as for example, 0, 1, and 2 to indicate the type of alteration at a particular location, such as High Hip, required for that particular consumer. In this way, the Salesperson is not bogged down by trying to get the perfect measurement using the clumsy tape measure. It should be appreciated that the use of unit numbers is exemplary and is not meant to be limiting, as other types of input can be used and still address the issue of convenience to the salesperson. The Salesperson simply clips the Clip at a certain location according to the comfort of the consumer. In one implementation, the Salesperson simply glances at the Alteration Point on the Tracer at which the Clip is positioned and can determine if a simple 0, 1, or 2 should be chosen as the metric for the consumer.

It should be appreciated that there are many possibilities of implementations, such as using a Smart Clip that has a chip that sends and receives signals from electronically configured Alteration Points on Tracers.

An Exemplary Tracer

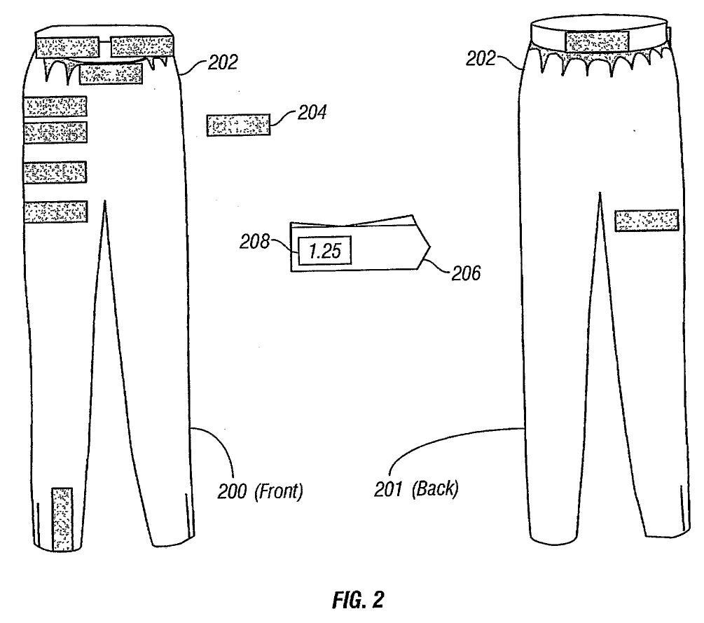

An exemplary tracer can be described with reference to FIG. 2, a schematic diagram showing the front 200 and back 201 views of a Tracer for a pant and a smart clip. A Tracer 202 is designed to fit on a customer to gather data that can be used to alter any number of available styles. Doing the measurements once allows the customer to re-order time and again and get the same personalized choice of fit, i.e. a reproducible process. Alteration Points 204, also referred to as TracerPoints, are points that are specific and their locations on the garment in question are carefully determined with testing. It has been determined through analysis that these locations, as shown on the pant in FIG. 2, both front and back, correspond to key fit points on a body that are the critical inputs to getting a good fit.

It should be appreciated that the process of determining the best locations for the alteration points on the pant can be applied to a limitless variety of different types of garments with success.

In one embodiment of the invention, the Clip is a Smart Clip 206. The Smart Clip in the figure shows a sample digital readout 208 of the metric, e.g. 1.25, that the CAD system would translate into the unique pattern for that particular consumer. In one embodiment of the invention, the Clip 206 is a Smart Clip and communicates with Alteration Points 204. It can read/sense its location on an Alteration Point. Or an Alteration Point can sense the clip's location on it. Digital readout 208 on the Clip 206 of measurement confirms an amount of alteration. In one embodiment of the invention, data from the Clip/Alteration Point interaction is wirelessly uploaded into specialized software that takes these measurements and creates a custom, unique pattern for that customer's personalized choice of fit, a combination of physical body shape and personal preferences for how the garment lays on and moves with the body. The manufacturing aspect of the made garment happens only after measuring.

It should be appreciated that the Tracer can't be a moving part in the process of ultimately satisfying the customer. In one embodiment of the invention, the Tracer is made of rigid material that does not substantially loose its shape.

Patternmaking Algorithms

It should be appreciated that in one embodiment of the invention, proprietary algorithms are employed that automatically adjust the base patterns in the customer's selected styles to the customer's shape.

Alter.dot data gathered from one Tracer can be used across all styles, in all fabrics in the same block.

An Exemplary System Architecture

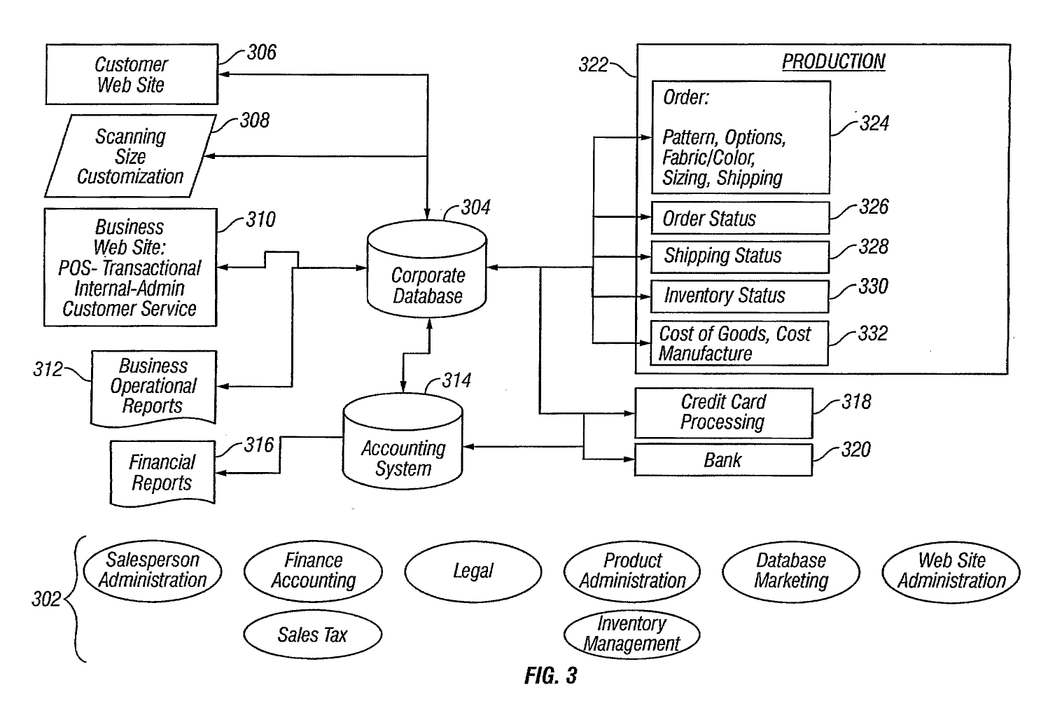

FIG. 3 is a schematic diagram showing an exemplary system architecture for implementing aspects of the invention. It should be appreciated that the specific architecture is for illustrative purposes only and is not meant to be limiting. One skilled in the art can implement the invention using one of a variety of possible system architectures and still be within the scope and spirit of aspects of the invention.

Referring to FIG. 3, Areas of responsibility 302 include, but are not limited to Salesperson Administration, Finance Accounting, Sales Tax, Legal, Product Administration, Inventory Management, Database Marketing, and Web Site Administration. A Corporate Database 304 is communicatively coupled to a Customer Web Site 306. Data passed between the Corporate Database and the Customer Web Site include, but are not limited to, scanning data, size data, and other customization data 308. The Corporate Database is communicatively coupled to a Business Web Site 310 configured to perform functionality related to a Point of Sale (POS) Transactional services, Internal Administrative services, and Customer Service. Business Operation Reports 312 are transferred between the Corporate Database 304 and the Business Web Site 310. The Corporate Database is communicatively coupled to an Accounting System 314, which produces Financial Reports 316. The Accounting System 314 is also communicatively coupled to a Credit Card Processing system 318 and a Bank 320. The Corporate Database 304 is also communicatively coupled to the Credit Card Processing system 318 and the Bank 320. The Corporate Database 304 is communicatively connected to a Production system 322 that includes, but is not limited to, Order processing using data including pattern, options, fabric, color, sizing, and shipping. The Production System further includes Order Status data 326, Shipping Status data 328, Inventory Status data 330, and Cost of Goods and Cost of Manufacturing data 332.

An Exemplary Process

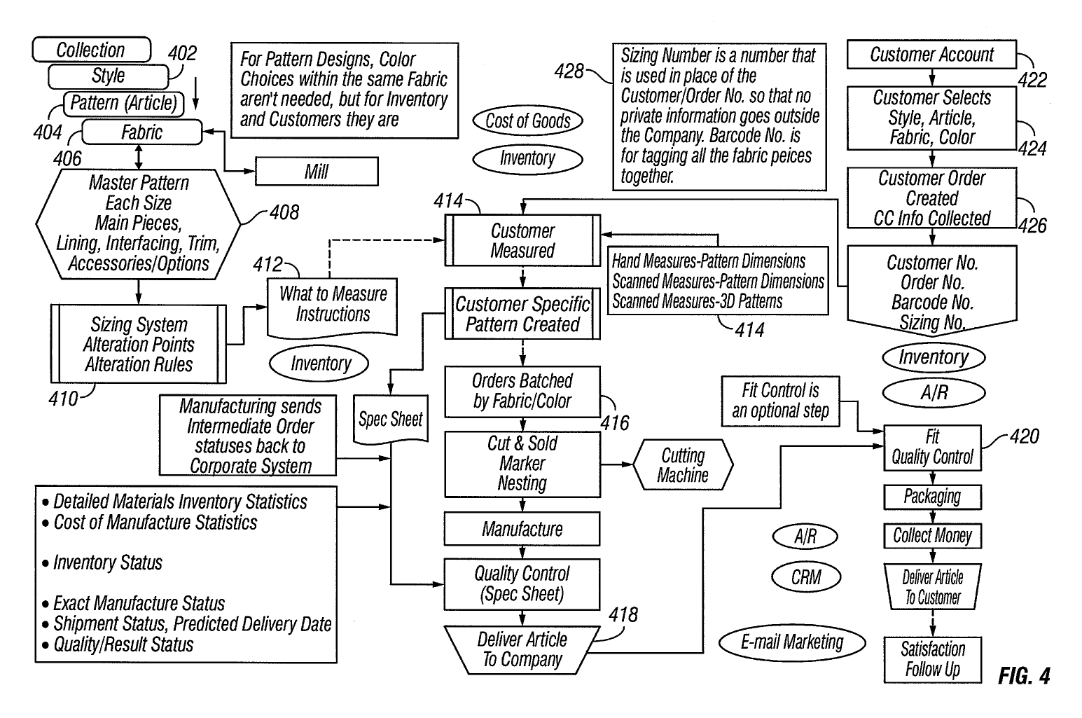

An exemplary process for one embodiment of apparel mass-customization can be described with reference to FIG. 4, a schematic interactive diagram showing the relationships between various elements concerning apparel mass-customization. It should be appreciated that references to the particular process is meant for illustrative purposes only and is not meant to be limiting. One skilled in the art can appreciate that other embodiments of the various components can be contemplated and can still be within the scope and spirit of the invention.

Various data representing aspects of style 402, pattern 404, fabric 406, and main pieces, lining, interface, trim, accessories, and the like towards one or more blocks 408 are input into a sizing component 410. The sizing component 410 employs alteration rules and alteration points to produce one or more set of instructions 412 describing what should be measured from the customer. A customer is measured using a variety of techniques, including measuring the pattern dimensions by hand, measuring the pattern dimensions by scanning, and measuring three dimensional (3D) dimensions by scanning 414. Orders can be grouped and batched by fabric and/or color 416. The process includes a quality control sub-process. The end product, i.e. the article is delivered 418 to a Fit Quality Control component 420 before being packaged and delivered to the customer.

Concerning reordering, from a customer account a customer can select a style, article, fabric, and color 424. A customer order is generated and payment information, such as credit card information, is collected 426. Sizing Number is a number that is used in place of the Customer/Order Number such that no private information goes outside the Company 428. A Barcode Number is used for tagging all the fabric pieces together 428. Once such data are gathered, control continues is if a customer has just been measured 414.

An Exemplary Database Schema

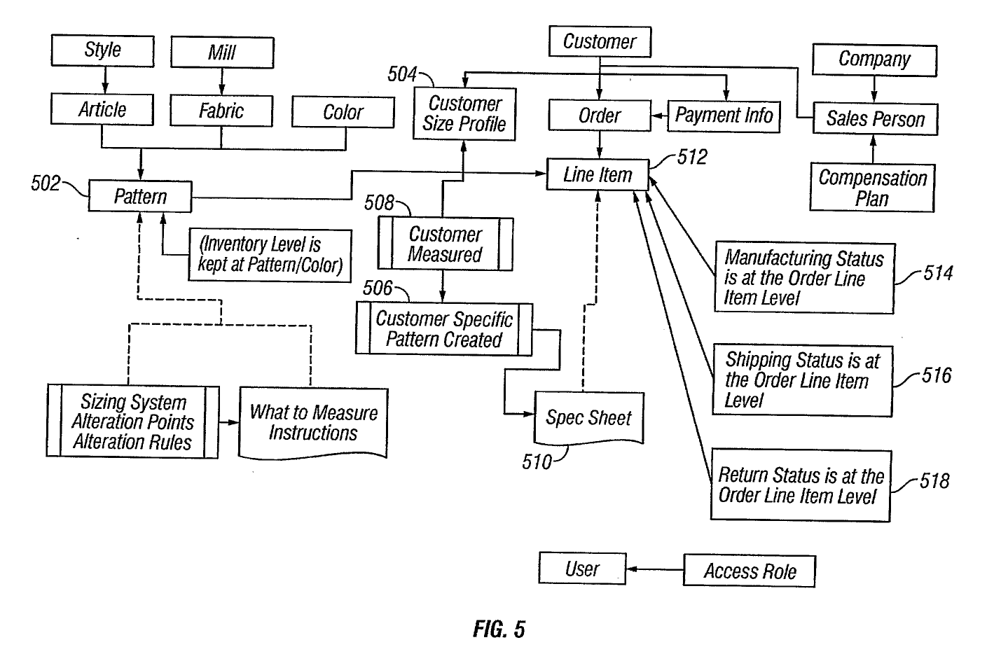

An exemplary database schema can be described with reference to FIG. 5. It should be appreciated that the specific organizational schema is for illustrative purposes and is not meant to be limiting. One skilled in the art can appreciate that other schemas can be employed and still be within the scope and spirit of the invention.

It should be appreciated that in one embodiment of the invention, inventory is kept at the Pattern level 502 within the database. That is, inventory is a type of electronic data stored in a database, as opposed to actual garments sitting on a shelf or in a box waiting to be purchased.

In another embodiment of the invention, inventory is kept at the customer size profile level 504. Again, such inventory is a type of electronic data stored in a database, as opposed to actual garments sitting on a shelf or in a box waiting to be purchased.

As hereinabove, a customer specific pattern is created 506, once the customer's measurements are determined 508. A specification sheet is generated 510 and stored as Order Line Item Level 512. Other data reflected on the Order Line Item Level 512 are Manufacturing Status 514, Shipping Status 516, and Return Status 518.

Sample Screens and Reports

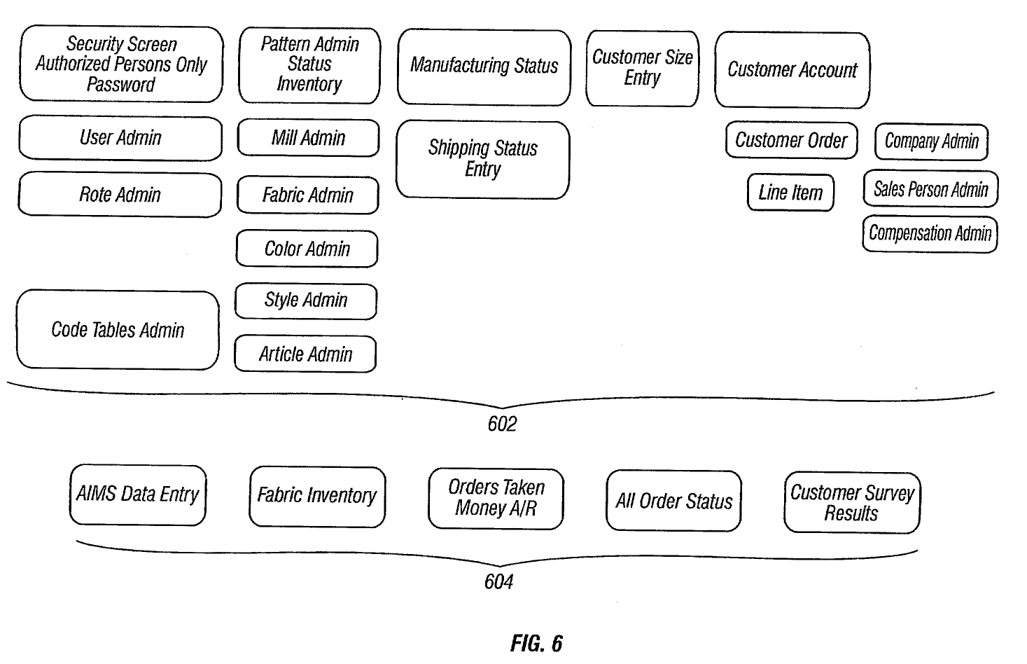

FIG. 6 shows an array of sample screens 602 and reports 604 that can be helpful and used in an apparel mass-customization. It should be appreciated that the specific screens 602 and reports 604 are for illustrative purposes and are not meant to be limiting. One skilled in the art can appreciate that other screens and reports can be employed and still be within the scope and spirit of the invention.

An Exemplary Business Architecture

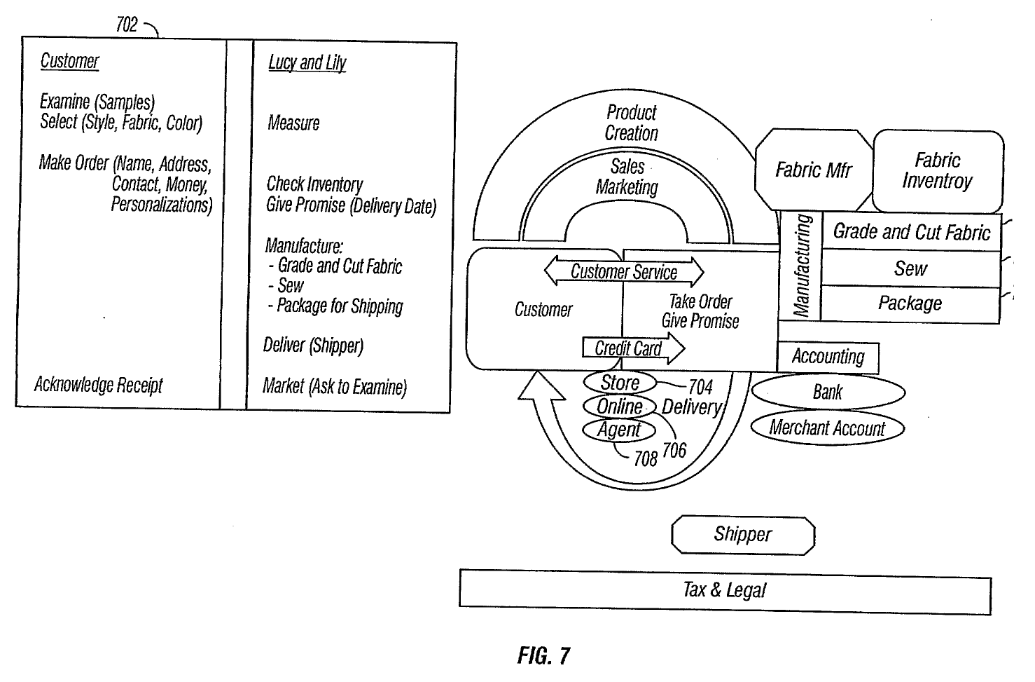

FIG. 7 shows an apparel mass-customization architecture from another perspective. On an ongoing basis, a customer can examine examples, select style, fabric, and color, and make an order 702. A customer can order from a store 704, online 706, or through an agent 708. FIG. 7 shows how the cutting 710, sewing 712, and packaging 714 components of the architecture can be independent, leading the way for more flexibility in the industry.

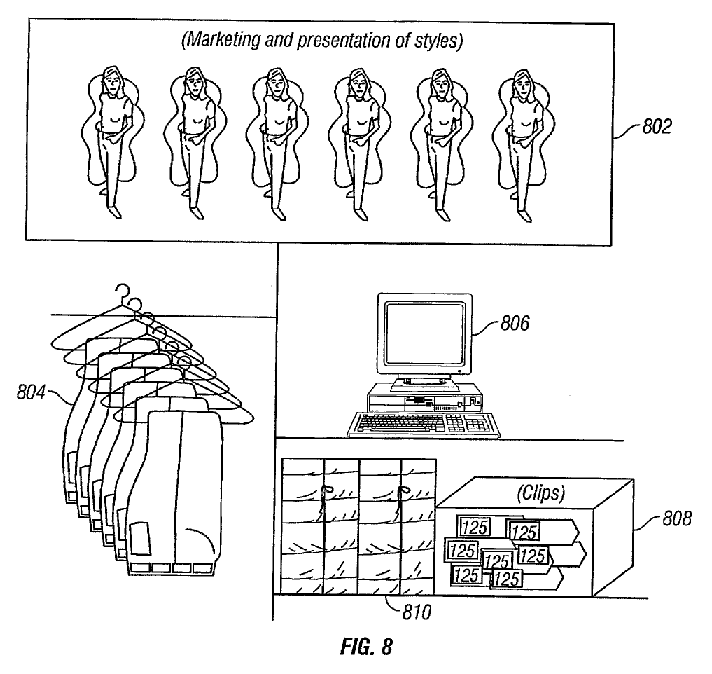

One embodiment of the invention provides a channel kiosk as shown in FIG. 8. This kiosk is illustrative only and is not meant to be limiting. A banner of some sort is displayed showing marketing and presentation of styles 802. One or more Tracers 804, most likely in different block sizes, are available for taking customers' measurements. A computer terminal 806 is configured and provided for viewing choices. Software on the terminal allows for 3D presentation of a customer's garment, e.g. pants, with the customer's choices and for ordering. One or more Clips 808 are provided. Examples of fabric, buttons, and other options 810 are available for the customer and other interested parties. Such kiosk can be set up in a house, in a small boutique, in a hotel room, e.g. by a direct Salesperson, or in a large specialty or department store.

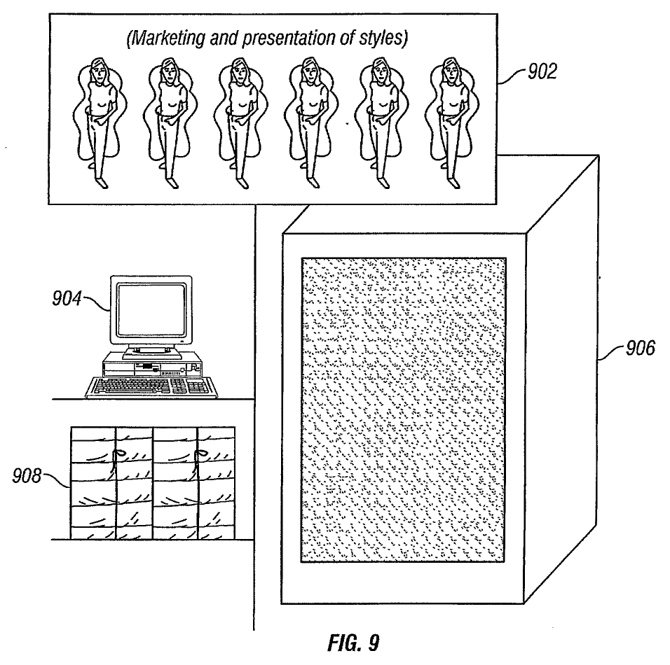

One embodiment of the invention provides a channel kiosk with scanner as shown in FIG. 9. This kiosk is illustrative only and is not meant to be limiting. A banner of some sort is displayed showing marketing and presentation of styles 902. A computer terminal 904 is configured and provided for viewing choices. Software on the terminal allows for 3D presentation of a customer's garment, e.g. pants, with the customer's choices and for ordering. A 3D Body Scanner 906 is provided. A customer's body can be scanned and a 3D scan can be uploaded into the system, which is coupled to the computer terminal. Garments, e.g. pants, can then be automatically rendered and shown on the customer's body. The system creates the customer's unique pattern from the 3D data and can manufacture pants to customer's body. Examples of fabric, buttons, and other options 908 are available for the customer and other interested parties. With a portable body scanner, such kiosk can be set up in a house, in a small boutique, in a hotel room, e.g. by a direct Salesperson, or in a large specialty or department store.

Accordingly, although the invention has been described in detail with reference to particular preferred embodiments, persons possessing ordinary skill in the art to which this invention pertains will appreciate that various modifications and enhancements may be made without departing from the spirit and scope of the claims that follow.

1. A method for apparel mass-customization, comprising the steps of:
a consumer putting on a tracer;
using one or more clips, a salesperson or other individual fitting said tracer to said consumer's fit and comfort;
for each clip, determining data based on the location of said clip in reference to an alteration point on said tracer, wherein said alteration point corresponds to a key fit point on a body, and wherein said data corresponds to an amount of alteration;
entering said determined data into a profile for said consumer, said consumer profile designed to store additional data, comprising data related to said consumer;
obtaining from said consumer data for an order;
inputting said consumer profile data and said order data into a configured CAD system;
based on said inputted data, said configured CAD system generating a pattern representing said order;
providing said pattern representing said order to a cutter;
said cutter cutting fabric based on said pattern;
packing said cut fabric, said pattern, and any further instructions based on said pattern, to a sewer or sewing facility;
said sewer or sewing facility sewing a garment based on said cut fabric, said pattern, and said any further instructions; and
providing said garment as a finished product for use by said consumer.

2. The method of claim 1, further comprising the step of:
placing said alteration point on said tracer such that said determined customer profile data is any of a few unit numbers, for the convenience of said salesperson, such that said configured CAD system takes as input any of said unit numbers and, based on an algorithm and said any of said unit numbers, dynamically adjust said pattern.

3. The method of claim 1, wherein said step of fitting said tracer to said consumer's fit and comfort further comprises allowing a user to move around in and sit in said tracer.

4. The method of claim 1, wherein the location of said cutter and said sewer are independent of each other and of said consumer.

5. The method of claim 1, wherein said Clip is a Smart Clip that has a chip that sends and receives signals from electronically configured Alteration Points on said tracer.

6. The method of claim 1, further comprising the step of:
said consumer requesting a second garment based a new order and based on said consumer profile data.

7. The method of claim 1, wherein said tracer is made of a material that retains its shape.

8. The method of claim 2, wherein said algorithm adjusts a base pattern based on said consumer's order, said order comprising said consumer's selected style, and based on said consumer's profile data.

9. The method of claim 1, wherein said consumer profile data can be used across all styles and in all fabrics in a same block.

10. The method of claim 1, further comprising the step of:
providing inventory in the form of electronic data, comprising at a pattern level or a color level.

11. The method of claim 1, further comprising the step of:
providing a channel kiosk that comprises one or more tracers in different block sizes, a computer terminal configured for providing viewing choices, one or more clips, and samples of fabric and other materials.

12. The method of claim 1, further comprising the step of:
providing a channel kiosk with scanner that a computer terminal configured for providing viewing choices;
providing a configured three-dimensional body scanner for scanning said customer's body and uploading said scan data into a configured system coupled to said computer terminal, wherein said computer terminal is configured to render garments on said consumer's body by said system; and
providing samples of fabric and other materials.

13. An apparatus for apparel mass-customization, comprising:
means for a consumer putting on a tracer;
means for using one or more clips, a salesperson or other individual fitting said tracer to said consumer's fit and comfort;
for each clip, means for determining data based on the location of said clip in reference to an alteration point on said tracer, wherein said alteration point corresponds to a key fit point on a body, and wherein said data corresponds to an amount of alteration;
means for entering said determined data into a profile for said consumer, said consumer profile designed to store additional data, comprising data related to said consumer;
means for obtaining from said consumer data for an order;
means for inputting said consumer profile data and said order data into a configured CAD system;
based on said inputted data, means for said configured CAD system generating a pattern representing said order;
means for providing said pattern representing said order to a cutter;
means for said cutter cutting fabric based on said pattern;
means for packing said cut fabric, said pattern, and any further instructions based on said pattern, to a sewer or sewing facility;
means for said sewer or sewer facility sewing a garment based on said cut fabric, said pattern, and said any further instructions; and
providing means for said garment as a finished product for use by said consumer.

14. The apparatus of claim 13, further comprising:
means for placing said alteration point on said tracer such that said determined customer profile data is any of a few unit numbers, for the convenience of said salesperson, such that said configured CAD system takes as input any of said unit numbers and, based on an algorithm and said any of said unit numbers, dynamically adjust said pattern.

15. The apparatus of claim 13, wherein said means for fitting said tracer to said consumer's fit and comfort further comprises allowing a user to move around in and sit in said tracer.

16. The apparatus of claim 13, wherein the location of said cutter and said sewer are independent of each other and of said consumer.

17. The apparatus of claim 13, wherein said Clip is a Smart Clip that has a chip that sends and receives signals from electronically configured Alteration Points on said tracer.

18. The apparatus of claim 13, further comprising:
means for said consumer requesting a second garment based a new order and based on said consumer profile data.

19. The apparatus of claim 13, wherein said tracer is made of a material that retains its shape.

20. The apparatus of claim 14, wherein said algorithm adjusts a base pattern based on said consumer's order, said order comprising said consumer's selected style, and based on said consumer's profile data.

21. The apparatus of claim 13, wherein said consumer profile data can be used across all styles and in all fabrics in a same block.

22. The apparatus of claim 13, further comprising:
inventory in the form of electronic data, comprising at a pattern level or a color level.

23. The apparatus of claim 13, further comprising:
a channel kiosk that comprises one or more tracers in different block sizes, a computer terminal configured for providing viewing choices, one or more clips, and samples of fabric and other materials.

24. The apparatus of claim 13, further comprising:
a channel kiosk with scanner that a computer terminal configured for providing viewing choices;
a configured three-dimensional body scanner for scanning said customer's body and uploading said scan data into a configured system coupled to said computer terminal, wherein said computer terminal is configured to render garments on said consumer's body by said system; and
samples of fabric and other materials.

25. A method for apparel mass-customization, comprising the steps of:
making a standardized garment having one or more alteration points at predetermined locations; and
providing a clip configured such that when a user is wearing said standardized garment and said clip is clipped at one of said one or more alteration points, an alteration value is determined based on said one of said one or more alteration points;
wherein said determined alteration value is used to alter a base pattern corresponding to said standardized garment to generate a customized pattern for making a customized garment.

26. An apparatus for apparel mass-customization, comprising:
a standardized garment configured with one or more alteration points at predetermined locations; and
a clip configured such that when a user is wearing said standardized garment and said clip is clipped at one of said one or more alteration points, an alteration value is determined based on said one of said one or more alteration points;
wherein said apparatus is configured such that said determined alteration value is used to alter a base pattern corresponding to said standardized garment to generate a customized pattern for making a customized garment.
